(19) United States
(12) Patent Application Publication
(10) Pub. No.: US 2025/0286158 A1
(43) Pub. Date: Sep. 11, 2025

(54) MULTI-FUNCTIONAL BATTERY PACK

(71) Applicant: Jiangsu Sesame Tools Co., Ltd., Qidong City (CN)

(72) Inventor: Jianhua Zhu, Qidong City (CN)

(21) Appl. No.: 19/220,012

(22) Filed: May 27, 2025

(51) Int. Cl. H01M 10/42; H01M 10/46; H01M 10/48

(52) U.S. Cl. CPC H01M 10/425; H01M 10/46; H01M 10/488

(57) ABSTRACT

A multi-functional battery pack includes a battery pack body, a plug interface discharge group and a cable discharge group. The plug interface discharge group includes a USB interface and a Type-C interface, and the cable discharge group includes a first cable and a second cable having different types of connector portions. The plug interface discharge and cable discharge functions are integrated into one battery pack, thereby improving versatility and adaptability of the battery pack.

### TECHNICAL FIELD

The present invention relates to the technical field of new energy electric tools and mobile power supplies, and in particular, to a multi-functional battery pack.

### BACKGROUND

Mobile battery packs, also known as mobile chargers, are now widely used in daily life. There are two common types of mobile battery packs. One type has a discharge plug interface on the battery pack, and an external cable is required to charge a device during use; and the other type has an own cable which can be directly connected with a device during use. However, different battery packs have different models of plug interfaces or cable connector portions, which may lead to a mismatch between the battery packs and the devices, resulting in low functionality and adaptability of the battery packs. Therefore, there is a need in the art for a mobile battery pack with multiple discharge functions and high adaptability.

### SUMMARY

An object of the present invention is to provide a mobile battery pack with multiple discharge functions and high adaptability.

In order to achieve the above object, the technical solution adopted by the present invention is specifically as follows: a multi-functional battery pack includes a battery pack body, and a plug interface discharge group and a cable discharge group are provided on the battery pack body; the plug interface discharge group includes a USB interface and a Type-C interface; the cable discharge group includes a first cable and a second cable, and the first cable and the second cable have different types of connector portions, such as a Lightning interface type connector portion and a Type-C interface type connector portion respectively. In addition, the plug interface discharge group may also be provided with other types of plug interfaces, and the cable discharge group may also be provided with cables with other types of interfaces.

In some other embodiments, the present invention also provides a multi-functional battery pack including a battery pack body, a plug interface discharge group and a cable discharge group; two accommodating grooves are provided on the battery pack body for accommodating a connector portion of a first cable and a connector portion of a second cable; one end of each of the accommodating grooves is provided with a wire groove for accommodating a wire portion of the first cable or a wire portion of the second cable; the plug interface discharge group includes a USB interface and a Type-C port; and the cable discharge group includes the first cable and the second cable, and the connector portion of the first cable is a Lightning connector, and the connector portion of the second cable is a Type-C connector. Here, the plug interface discharge group and the cable discharge group are disposed on the battery pack body; and state display lights are provided on both sides of the battery pack body for displaying power level and working state of the battery pack. Furthermore, a groove width of the wire grooves is smaller than a groove width of the accommodation grooves, the two accommodating grooves are respectively provided with an arc-shaped wall at the other ends away from the wire grooves, and the connector portion of the first cable and the connector portion of the second cable are both disposed below the arc-shaped walls.

Compared with the prior art, the present invention has the following beneficial effects:
1. The battery pack of the present invention integrates plug interface discharge and cable discharge functions, providing “Bij user with multiple discharge methods. If the connector portion of the cable is not compatible, other external cables may be connected for use, thereby improving versatility and adaptability of the battery pack.
2. When the first cable (e.g., a Lightning cable) or the second cable (a Type-C cable) is used, the connector portion of the cable can be held down with a finger and pushed toward the arc-shaped wall of the accommodating groove to allow the connector portion to move forward and move up along the arc-shaped wall of the accommodating groove; and at the same time, the wire portion of the cable further moves into the wire groove, and when the connector portion of the cable moves up along the arc-shape wall to protrude from the accommodating groove, the connector portion of the corresponding cable can be taken out, and then the cable can be pulled out.
3. Combining the functionality and adaptability of new energy electric tool battery packs with mobile battery packs further increases applicability of the product.

### BRIEF DESCRIPTION OF THE DRAWINGS

The accompanying drawings, which are included to provide a further understanding of the present invention and constitute a part of the specification, illustrate the present invention together with the embodiments and do not constitute a limitation to the present invention.

FIG. 1 is a schematic structural diagram of an embodiment of the present invention.

Here, reference numerals in the drawings are as follows: 1. battery pack body; 11. state display light; 12. accommodating groove; 121. second friction member; 13. wire groove; 2. plug interface discharge group; 21. USB interface; 22. Type-C interface; 3. cable discharge group; 31. first cable; 32. second cable; and 33. first friction member.

### DESCRIPTION OF THE EMBODIMENTS

To make the purpose, technical solution and advantages of the present invention more clear, the present invention will be further described in detail below in conjunction with the accompanying drawings and embodiments. It should be understood that the specific embodiments described herein are merely illustrative of the present invention and are not meant to limit the present invention.

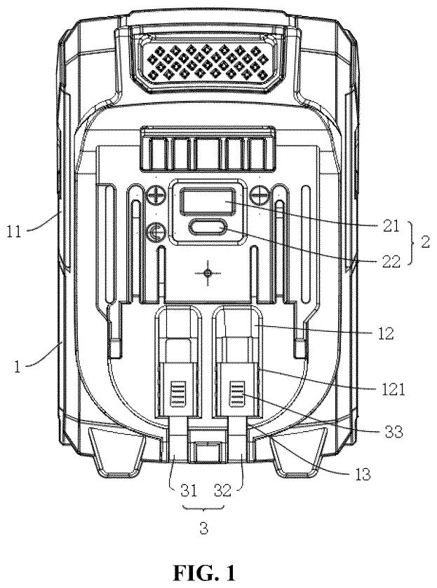

Referring to FIG. 1, the technical solution provided by the present invention is as follows: a multi-functional battery pack includes a battery pack body 1, and a plug interface discharge group 2 and a cable discharge group 3 are provided on the battery pack body 1; the plug interface discharge group 2 includes a USB interface 21 and a Type-C interface 22; and the cable discharge group 3 includes a first cable 31 and a second cable 32, where he first cable 31 and the second cable 32 have different types of interfaces, for example, the first cable 31 is a Lightning cable 31 with a Lightning connector, and the second cable 32 is a Type-C cable 32 with a Type-C connector.

Preferably, the plug interface discharge group 2 and the cable discharge group 3 of the battery pack may not be limited to the types described herein. When the battery pack is manufactured, other types of plug interfaces can be added to the plug interface discharge group 2. Similarly, cables with other types of interfaces can also be added to the cable discharge group 3.

Moreover, the Type-C interface 22, in addition to having the function of discharging to the outside, can also be used to charge the battery pack after being connected to an external power source.

Preferably, state display lights 11 are provided on both sides of the battery pack body 1 for displaying power level of the battery pack. For example, the state display lights 11 are composed of a plurality of lamp beads; when the power is full, the state display lights 11 are all lit; when the power is insufficient, only some of the state display lights 11 are lit according to the proportion of the remaining power; and when there is no power, the state display lights 11 are all off.

The battery pack of the application integrates plug interface discharge and cable discharge methods, providing a user with multiple discharge modes. If the type of the connector portion of the cable is not compatible, the user can also connect other cables to the plug interface for use. Moreover, the power usage can also be observed according to the state display lights 11 when in use, thereby improving versatility and adaptability of the battery pack.

Preferably, two accommodating grooves 12 are provided on the battery pack body 1, a wire groove 13 is provided at one end of each of the accommodating grooves 12, a groove width of the wire grooves 13 is smaller than a groove width of the accommodating grooves 12, and a groove depth of the wire grooves 13 is also larger than a thickness of the wire portion to accommodate wires therein.

Preferably, the connector portion of the Lightning cable 31 and the connector portion of the Type-C cable 32 are respectively inserted into the corresponding accommodating grooves 12, and the wire portion of the Lightning cable 31 and the wire portion of the Type-C cable 32 are respectively connected to the two wire grooves 13; and the accommodating grooves 12 are respectively provided with an arc-shaped wall at the other ends away from the wire grooves 13, and the connector portion of the Lightning cable 31 and the connector portion of the Type-C cable 32 are located below the arc-shaped walls of the corresponding accommodating grooves 12.

Preferably, the connector portions of the Lightning cable 31 and the Type-C cable 32 are both provided with a first friction member 33. The first friction member 33 is made of an elastic rubber material. Persons skilled in the art may also select a plastic material, or select the same material as the connector portion of the cable. Preferably, the first friction member is integrally formed on the connector portion of the corresponding cable.

When the Lightning cable 31 or the Type-C cable 32 is used, the connector portion of the cable can be held down with a finger and pushed toward the arc-shaped wall of the accommodating groove 12 to allow the connector portion to move up along the arc-shaped wall of the accommodating groove 12; and at the same time, the wire portion of the cable further moves into the wire groove 13, and when the connector portion of the cable moves up along the arc-shape wall to protrude from the accommodating groove 12, the connector portion of the cable can be taken out, and then the cable can be pulled out.

Preferably, a second friction member 121 is respectively provided on left and right side walls of the two accommodation grooves 12; the second friction member 121 is made of an elastic rubber material; when the Lightning connector of the Lightning cable 31 or the Type-C connector of the Type-C cable 32 is inserted into the accommodation groove 12, the Lightning connector or the Type-C connector abuts against the corresponding friction member 121, thereby increasing the friction force to limit the connector portion of the Lightning cable 31 and the connector portion of the Type-C cable 32 and prevent the connector portions from coming out.

What is claimed is:

1. A multi-functional battery pack, comprising:
a battery pack body,
a plug interface discharge group comprising a USB interface and a Type-C interface; and
a cable discharge group comprising a first cable and a second cable, the first cable and the second cable having different types of connector portions; and
wherein the plug interface discharge group and the cable discharge group are disposed on the battery pack body.

2. The multi-functional battery pack according to claim 1, wherein state display lights are provided on both sides of the battery pack body for displaying power level and working state of the battery pack.

3. The multi-functional battery pack according to claim 1, wherein two accommodating grooves are provided on the battery pack body for accommodating the connector portion of the first cable and the connector portion of the second cable; one end of each of the accommodating grooves is provided with a wire groove for accommodating a wire portion of the first cable or a wire portion of the second cable.

4. The multi-functional battery pack according to claim 3, wherein a groove width of the wire grooves is smaller than a groove width of the accommodation grooves, the two accommodating grooves are respectively provided with an arc-shaped wall at the other ends away from the wire grooves, and the connector portion of the first cable and the connector portion of the second cable are disposed below the arc-shaped walls.

5. The multi-functional battery pack according to claim 4, wherein a first friction member is provided on the connector portion of the first cable or the connector portion of the second cable for increasing a friction force between a finger and the connector portion.

6. The multi-functional battery pack according to claim 4, wherein a second friction member is provided on inner walls on both sides of the accommodating grooves, and the connector portion of the first cable or the connector portion of the second cable abuts against the second friction member.

7. The multi-functional battery pack according to claim 1, wherein the connector portion of the first cable is a Lightning connector, and the connector portion of the second cable is a Type-C connector.

8. A multi-functional battery pack, comprising:
a battery pack body, two accommodating grooves being provided on the battery pack body for accommodating a connector portion of a first cable and a connector portion of a second cable;
one end of each of the accommodating grooves being provided with a wire groove for accommodating a wire portion of the first cable or a wire portion of the second cable;
a plug interface discharge group comprising a USB interface and a Type-C interface; and
a cable discharge group comprising a first cable and a second cable, the connector portion of the first cable being a Lightning connector, and the connector portion of the second cable being a Type-C connector; and
wherein the plug interface discharge group and the cable discharge group are disposed on the battery pack body; and state display lights are provided on both sides of the battery pack body for displaying power level and working state of the battery pack; and
a groove width of the wire grooves is smaller than a groove width of the accommodation grooves, the two accommodating grooves are respectively provided with an arc-shaped wall at the other ends away from the wire grooves, and the connector portion of the first cable and the connector portion of the second cable are both disposed below the arc-shaped walls.

9. The multi-functional battery pack according to claim 8, wherein a first friction member is provided on the connector portion of the first cable or the connector portion of the second cable for increasing a friction force between a finger and the connector portion.

10. The multi-functional battery pack according to claim 8, wherein a second friction member is provided on inner walls on both sides of the accommodating grooves, and the connector portion of the first cable or the connector portion of the second cable abuts against the second friction member.
